(19) United States
(12) Patent Application Publication
(10) Pub. No.: US 2025/0342817 A1
(43) Pub. Date: Nov. 6, 2025

(54) SYSTEMS AND METHODS FOR A VOICE-KEY DATABASE

(71) Applicant: WELLS FARGO BANK, N.A., San Francisco, CA (US)

(72) Inventors: Christopher Barath, Chandler, AZ (US); Shannon H. Chang, Tucson, AZ (US)

(21) Appl. No.: 18/652,524

(22) Filed: May 1, 2024

(51) Int. Cl. G10L 13/08; H04L 9/40; H04M 3/42

(52) U.S. Cl. CPC G10L 13/08; H04L 63/08; H04L 63/104; H04M 3/42068

(57) ABSTRACT

Systems and methods for providing secure access to a voice key database are disclosed. The voice key database stores associations between audio inputs, contacts, and voice seeds, leading to synthetic voice outputs. The described embodiments allow for a first set of users to modify voice seed associations. A second set of users may also control the first set of users' ability to modify the voice seed associations. One disclosed system includes one or more processors and memory with stored instructions which when executed by the one or more processors cause the one or more processors to identify a contact associated with an audio input by an input entity; retrieve a voice seed associated with the contact; and generate a synthetic voice based in part on the voice seed and the input.

### FIELD OF TECHNOLOGY

The present disclosure generally relates to automated voice modulation applied to unique voice seeds and more particularly to systems and methods for generating synthetic voices associated with voice seeds and associated with inputs received by a first or second caller.

### BACKGROUND

The advent of generative artificial intelligence has made voices easy to capture and replicate with recording devices with as little as a 3 second sample. Existing technologies allow for a speaker's voice to be recorded and replicated, permitting bad actors to copy another's voice. Such auditory “deepfake” technology, aka voice spoofing, presents risks to various users and industries wherein a caller's voice serves as a form of identification and authentication. Thus, there is a need for a system that can generate synthetic voices based in part on associating unique voice seeds with users and applying those voice seeds to users based on the same or other users' identities.

### SUMMARY

According to certain embodiments, a system for generating a synthetic voice may comprise one or more processors that perform operations to identify a contact associated with a first or second caller; retrieve a voice seed associated with the contact; and generate a synthetic voice based in part on applying the associated voice seed and an input from the first or second caller.

According to another embodiment, a method for generating a synthetic voice may comprise: identifying a contact associated with a first or second caller; retrieving a voice seed associated with the contact; and generating a synthetic voice based in part on the associated voice seed and an input from the first or second caller.

According to another embodiment, a non-transitory computer readable medium may comprise program code, which when executed by one or more processers, causes the one or more processors to perform operations including identifying a contact associated with a first or second caller; retrieving a voice seed associated with the contact; and generating a synthetic voice based in part on applying the associated voice seed and an input from the first or second caller.

This illustrative example is mentioned not to limit or define the limits of the present subject matter, but to provide an example to aid understanding thereof. Illustrative examples are discussed in the Detailed Description, and further description is provided there. Advantages offered by various examples may be further understood by examining this specification and/or by practicing one or more examples of the claimed subject matter.

### BRIEF DESCRIPTION OF THE DRAWINGS

A full and enabling disclosure is set forth more particularly in the remainder of the specification. The specification makes reference to the following appended figures.

FIG. 1 illustrates a block diagram for a system for generating a synthetic voice based in part on identities stored in a voice key database according to one embodiment.

FIG. 2 illustrates a block diagram for a system for generating a synthetic voice based in part on identities stored in a voice key database, and modifying the synthetic voice based on the associated voice seed.

FIG. 3 illustrates a block diagram for a system for generating a synthetic voice based in part on identities stored in a voice key database, wherein the system further includes an authenticator module including security measure components and access filtration related to different sets of users according to another embodiment.

FIG. 4 illustrates a flow chart for a method of modifying a voice seed based on filtered access to a user environment according to another embodiment.

FIG. 5 illustrates a block diagram for an example user interface allowing for modification of synthetic voice characteristics according to another embodiment.

FIG. 6. illustrates a flow chart for a method of storing an audio input voiceprint associated with a contact, and for generating and modifying a synthetic voice based on audio input characteristics according to another embodiment.

FIG. 7. illustrates a flow chart for a method of generating and modifying both contacts and a synthetic voice according to another embodiment.

FIG. 8 illustrates a block diagram for an example computing environment capable of executing the described systems and methods.

### DETAILED DESCRIPTION

The rise of voice spoofing and other deepfake technologies represents a vulnerability in current digital voice-based communication. Embodiments described herein provide techniques to protect a caller or callee's voiceprint from replication.

### Illustrative Embodiment of a Voice Key Database

In one illustrative embodiment, a voice key database comprises an application executed on a computer or mobile device for generating a synthetic voice associated with a caller. In the illustrative embodiment, the synthetic voice is based in part on a voice seed and a caller's voice input. For example, a user can access the voice key database through an application on a mobile phone (a “mobile app”) and designate specific contacts with specific voice seeds. While a mobile app is referred to as providing the user interface, the software and user interface implementing the voice key database may be applied on any computer, mobile device, or other electronic device.

Using the mobile app, the user can then designate a specific voice seed to unknown or anonymous callers. Then, when an unknown caller calls the user, the user's voice will be modified by the voice seed associated with the unknown caller. The voice seed modifies the user's voice input to create a synthetic voice heard by the unknown caller. The synthetic voice effectively masks the user's natural voice or voiceprint and prevents the unknown caller from capturing and replicating the user's voiceprint.

In some embodiments, using the mobile app, the user may tune characteristics of each voice seed to render them more desirable or accessible to the associated contact. The user may know a contact to be hard of hearing and may edit the voice seed associated with the contact in a user interface. The edited voice seed could be pitch shifted to a higher or lower frequency to render the resulting synthetic voice more accessible to the associated contact. In another exemplary use, the user can, through a user interface of the voice key database, associate the voice seed with contact such that the voice seed modifies another caller's voice heard by the user. The user can thus render other caller's voices more desirable to the user themselves through an associated voice seed applied to the other caller's voice.

In a further illustrative embodiment, the mobile app is controlled by a secondary, enterprise user who themself is not a caller. In some cases, the callers requiring synthetic voice protection are text to speech automated software. Using a computer application, the system administrator can associate voice seeds with any set of contacts calling over network. The system administrator may associate voice seeds with unverified callers such that the user's voice is modified by the voice seed to generate the synthetic voice heard by the unverified caller. For instance, an unverified caller may call into an automated phone line presenting a risk that an automated user's voiceprint may be captured and replicated. The enterprise user can then associate the unverified caller with a voice seed unique to that unverified caller so that the automated user's synthetic voice is unique to that unverified caller.

### Example Embodiments of a Voice Key Database

In some embodiments, a user or first caller may use the disclosed system and methods to protect outbound audio sent to a second caller or group of second callers (or “callees”). For instance, a user may, through a user interface, associate specific contacts in a voice key database with specific voice seeds. When calling the specific contacts or receiving calls from those contacts, the associated voice seed will be applied to the user's voice to generate a synthetic voice, masking the user's unique voice and protecting the user from having their voiceprint replicated by a callee or third-party eavesdropper.

A unique voice seed may be associated with each unique contact, preventing callees or third parties from replicating the user's voiceprint or synthetic voice associated with a second contact when the third party or eavesdropper attempts to call the second contact. Unidentified or anonymous callers, as a class of contacts, may be associated with a voice seed such that a caller's natural voice will be masked by a synthetic voice generated in part by the voice seed. In other embodiments, an enterprise may use the disclosed systems and methods to protect the first and/or second caller's identities. In some embodiments, when receiving calls from specific contacts, an enterprise may associate a voice seed with each caller within an enterprise system depending on their identity. In such cases, the enterprise may protect callers' identities from being replicated.

While reference is made throughout from the perspective of a first caller, any caller or callee within a calling network may use the described voice key database to the caller's or callee's outbound audio or voiceprint. Each caller or callee may similarly use the voice key database to modify other's voice outputs. Moreover, each party to a call may use the techniques described herein during the same call. For instance, in a conference call, one or more callers may have associated the other callers within the call with specific voice seeds. During the call, each caller who has associated the other callers with a voice seed may have their audio input modified to produce a synthetic voice.

Embodiments described herein may also implement additional security measures to the voice key database. Various authenticator modules including, encryption and certificate programs, authenticator applications, and security filters may be used in limiting access to the voice key database. For instance, a user may be required to log in through two factor authentication, be verified from an enterprise administrator in a user group, enter passwords, or use voiceprint-based authentication to access the voice key database in a user, or to access a subset of the voice key database. In limiting access, specific voice seeds and the resulting generated voice seeds may be associated with various levels of access into a secured setting.

In some embodiments security measures may coincide with enterprise security systems. Authenticators and other security filtration mechanisms may be applied through preexisting enterprise security measures. Upon accessing an enterprise system through Single Sign-On or a Virtual Private Network, an enterprise user may have access to the voice key database or a subset of the voice key database. The enterprise user with access to a heightened user group then may be granted the ability to modify voice seed associations and other voice seed characteristics between callers, callees, and other users communicating through the enterprise network.

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure includes modifications and variations as come within the scope of the appended claims and their equivalents.

### Example Systems for a Voice-Key Database

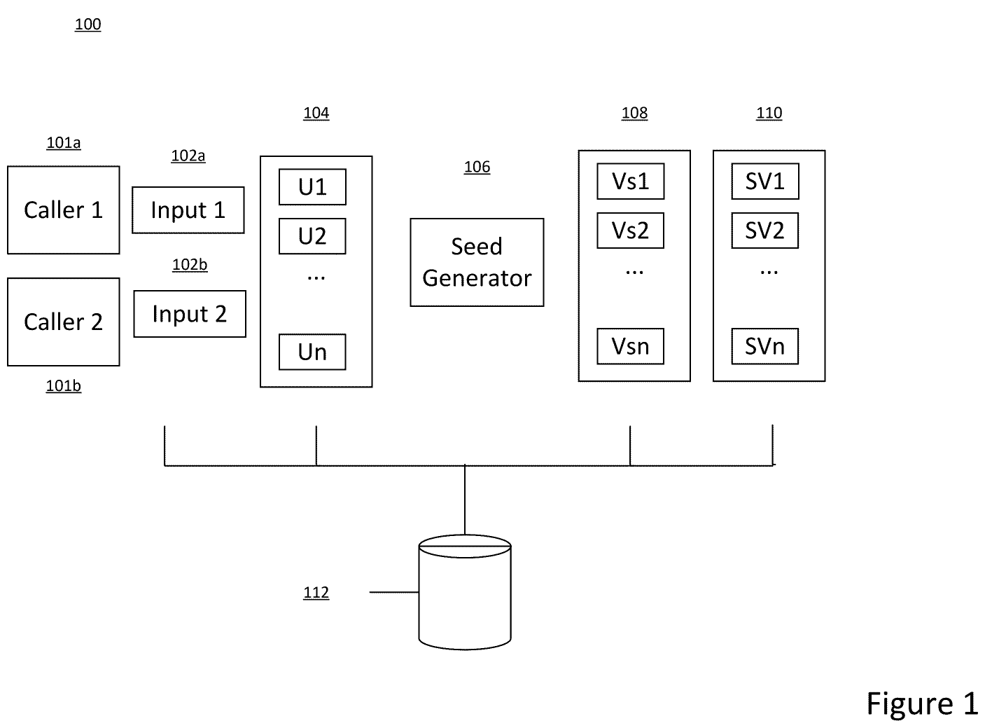

FIG. 1 is a block diagram depicting an example of a synthetic voice generation system 100 in which a voice seed generator 106 generates a voice seed 108 which, when coupled with one of callers' 101a 101b inputs 102a 102b, generates a synthetic voice 110. The voice seed 108 is associated with a contact 104 and the voice seed-contact association is stored in the voice key database 112.

In one embodiment, the first caller 101a may be a human and the input 102a is the human's voice input over a call. The voice input 102 can be picked up and recorded electronically by traditional signal processing means. For instance, the voice-key database 112 can be integrated into a mobile device, seamlessly integrating a person's audio input into the system 100. The input 102 may be an analog input, for instance received by an analog phone such as within a POTS system or may be a digital input received by a digital system such as cell phone or an Internet Protocol phone. In the same or another embodiment, the first caller 101a may be a non-human caller such as an automated caller inputting Text to Speech (TTS) output. Their input 102a can then be the text to be converted by TTS simulation software. In such embodiments, the voice characteristics of the TTS output may be varied according to techniques of this disclosure. The first caller's 101a natural human voice characteristics, or voiceprint, may require protection from unidentified or anonymous second callers 101b. In cases where the first caller is automated TTS output, the default voice of the TTS output may still require masking or variation between calls to different second callers.

In one embodiment, the contact 104 associated with the input 102 is a person or number that the first caller 101a (also referred to as “the user”) plans to call or receive calls from, which can be the second caller 101b. The second caller 101b can be any variety of caller identifiable or unidentifiable to the first caller 101a. In a mobile device embodiment, the voice key database may have access to the user's contact information and can import that data into the voice key database 112. The user 101a can then associate each contact 104 within their phone with a specific voice seed 108 through a user interface. Then, when the user 101a calls or receives a call from that contact 104 associated with a second caller 101b, the user's 101a voice will be modified by the voice seed 108 to generate the synthetic voice 110. The second caller 101b will only hear the synthetic voice 110 associated with the first caller 101a and not the first caller's natural voiceprint input 102a.

The first caller 101a can generate unique voice seeds 108 corresponding to each unique contact 104 in their phone. The first caller 101a can also associate classes or subclasses of contacts 104 with voice seeds. For instance, the caller 101a may associate all unidentified or anonymous second callers 101b with a default voice seed 108 such that the second callers 101b hear a default synthetic voice 110 masking the first caller's 101a natural voice input 102a. The first caller can associate contacts of second callers 101b calling from specific area codes or locations with a specific voice seed 108 for similar purposes. The first caller 101a can associate contact of the second caller 101b with a specific voice seed 108 based on any identifiable metadata associated with the second caller 101b. Alternatively, the first caller 101a may associate unidentified or anonymous callers with a randomly generated voice seed 108 unique to each call. The first caller 101a may revise voice seed associations, revoke voice seed associations with contacts, or refrain from assigning voice seed associations to contacts. In cases where voice seeds are revoked or not assigned, the second caller 101b associated with the contact 104 will hear the first caller's unmodified input 102a which could be the first caller's natural voiceprint, or the default text to speech output characteristics of an automated caller when the first caller is automated.

In one embodiment, the voice seed 108 operates as a modifying function, where it receives input 102, which can be an audio input, and generates a synthetic voice output 110. When associated with an input 102, the voice seed 108 can use digital signal processing techniques to add features such as frequency modulation, amplitude modulation, or phase modulation to the input 102 to generate the modified output synthetic voice 110. A user interface providing access to these modulations can be provided to a user control group who can modify parameters of the voice seed 108. Additional signal processing techniques may be provided such as providing default voice seeds within the user interface.

In some embodiments the voice seed 108 can be a hash code, or other unique identifier, which informs the voice seed generator 106 how to modify the audio input 102. The voice seed 108 can direct inputs 102 to a specific generator function within the seed generator 106 associated with specific audio characteristics as described above such as frequency, amplitude, and phase modulation.

Each voice seed 108 can be unique to a specific contact or can be associated with more than one contact. The voice seed 108 may be generated on first use from one caller 101a to another 101b. One caller 101a may be able to generate a new voice seed 108 during a call with another caller 101b. For instance, the first caller 101a, may during a call with the second caller 101b, lose trust in the second caller's 101b identity. The first caller 101a may then, through a user interface, generate a new voice seed 110 associated with the second caller 101b during the call, resulting in the first caller's input 102a immediately being masked by the associated synthetic voice 110. Once generated, the voice seed 108 may be saved and stored for future calls to or from a specific caller-contact association. Then, when future calls are made to the specific contact, the voice seed 108 may be automatically applied to the user's input without further user interaction through a user interface.

Similarly, a caller 101a may want to turn off any associated voice seeds during a call with a second caller 101b. For instance, the first caller 101a may gain confidence in the authenticity of the second caller 101b. During the call, the first caller 101a may use the user interface to turn off a voice seed associated with the second caller 101b, such that the second caller 101b will then hear the first caller's natural voice input 102a.

In some embodiments, the first caller 101a may want to protect their voiceprint from a group of second callers 101b during a conference call. The first caller 101a may associate the contacts to be called with a voice seed such that the group of second callers 101b, the other participants to the call, all hear a synthetic voice output from the first caller 101a. In another example, both the first caller 101a and the second caller 101b may associate each other's contact 104 with a voice seed 108.

In some embodiments, the first caller 101a may associate the other caller's 101b contact 104 with a voice seed 108 such that the second caller's 101b input 102b is masked or altered by a synthetic voice 110 heard by the first caller 101a. Using a user interface, the first caller may improve audio quality from certain other callers 101b. Using the voice key database 112, the user 101a may associate through the voice seed generator 106 the second caller 101b with a voice seed 108 and save the voice seed association for future calls from the second caller 101b. In future calls from the second caller 101b, the first caller 101a will hear a synthetic voice 110 generated by applying the voice seed 108 associated with the second caller's 101b input 102b.

Voice seeds 108 may produce synthetic voices 110 which retain different characteristics of audio input 102. With some voice seeds, the synthetic voice may only shift the associated caller input 102 pitch or tone. With other seeds, the synthetic voice 110 may be unrecognizable compared to the audio input 102. The synthetic voice, depending on the voice seed, can retain varying levels of input 102 characteristics. The voice seed generator 106 may, in some embodiments, be input with voice seed parameters to modify or control the specific voice seed associated with a contact, and thus the associated synthetic voice associated with the output.

The voice seed generator 106 generating the voice seeds 108 may be completely randomized. For instance, the voice seed generator may generate a voice seed from a random number generator. Various random number generators can be used including algorithmic pseudorandom number generators or cryptographically secure pseudorandom number generators. Thus, once a user requests a generated voice seed 108, the voice seed generator 106 may generate a random hash code linked to a specific contact 104, such as the second caller 101b and store that association in the voice seed database 112.

In other embodiments, the voice seed generator 106 may be partially randomized or manually modified to allow a user with granted access partial or complete control over associating specific voice seeds 110 with contacts 104, or otherwise modifying the synthetic voice output 110 associated with the audio input 102. In such cases, the user can exert control over a contact's 104 associated synthetic voice 110. The synthetic voice 110 may partially or completely mask characteristics of the first caller 101a or second caller's 101b input 102. Partial masking includes voice modifications that change only a subset of the audio input characteristics, such as pitch shifting or adding reverb. Partial masking may also include adding audio characteristics or other metadata that identify a caller while also being inaudible to the human ear. In such cases, the audio input 102 is “masked” in that an audio recorder will record the audio metadata inaudible to the human ear, but otherwise identifiable by a computer processor. Complete masking includes synthetic voice modifications that retain few, if any, identifying voiceprint characteristics of the audio input 102. Complete masking includes default voice seeds which produce default synthetic voices, or other audio distinct from the user audio input 102.

Once the voice seed-contact associations are created, the voice key database 112 can store the voice seed-contact associations, as well as other metadata for each of the contacts 104. The metadata can include data specifying which caller's input to apply the contact associated voice seed to. For instance, the voice seed associated with the contact further includes metadata telling the voice seed generator 106 to apply the voice seed to the first caller or second caller input. The voice seed database 112 can store characteristics of the audio inputs 102, and voice seeds 108. The voice seeds 108 for instance may comprise hash values stored in the voice seed database 112.

Some callers may be automated and provide text to speech inputs. In some instances, artificial intelligence and machine learning may be used to generate the input 102 that is used conjunction with one or more voice seeds to carry conversations with specific first or second callers. An enterprise user, or other user may manually associate specific contacts 104 with specific voice seeds. Then, once a non-automated caller calls the automated caller, the automated caller's TTS input can be modified by an associated voice seed to augment the non-automated caller's experience. Specific voice seeds may be associated with specific contacts, or tasks performed by the automated caller.

The voice seeds 108 may be used to change the perceived communication experience for a second caller with an automated first caller supplying the audio input 102. In some embodiments, AI models and machine learning may be applied in real time to the conversation. The voice seed generator 100 may receive a second caller's responses to first caller input 102, process those responses, and apply text-based generative AI models to generate a selected response. The selected response may then be output through a voice seed 108 associated with the contact 104 to generate a synthetic voice output 110. In the above instances where AI is used to carry on conversations with callees, text-based generative AI models such as GPT-3, GPT-4, LaMDA, BLOOM, or other generative AI text predictive tools may be used to generate the underlying text-based responses to caller-callee conversations.

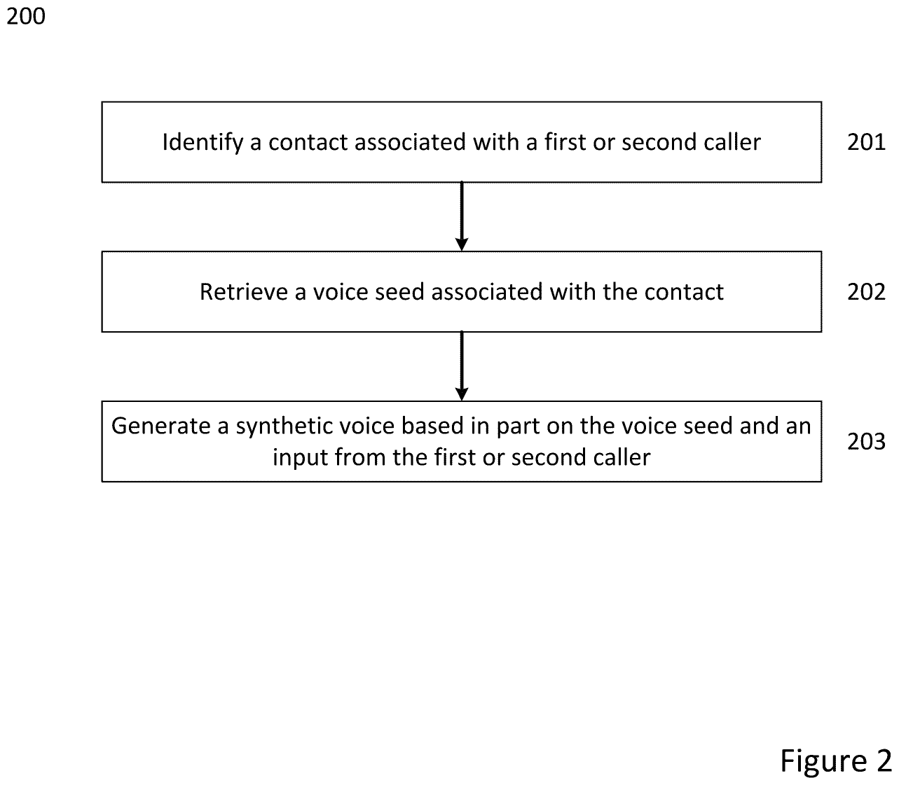

FIG. 2 illustrates a flow chart 200 according to an embodiment of the disclosure. In an exemplary embodiment, a mobile user receives a call from a second caller. Upon receiving the call from the second caller, the voice seed generator identifies a contact associated with the second caller. The voice seed generator may then retrieve a voice seed associated with the contact of the second caller. The voice seed may contain metadata informing which input, between the first caller input or the second caller input, to apply the voice seed associated with the contact to. The voice seed generator can thus use the mobile user's phone contacts to identify the second caller, and analyze metadata related to the second caller. For instance, if the second caller is an unidentified number in the user's phone, the voice seed generator can retrieve a voice seed that is associated with unknown callers. This may be a default voice seed that outputs audio retaining few audio characteristics of an audio input. During the call, the voice seed generator can then generate a synthetic voice based in part on the retrieved voice seed, and an input from the first caller. In effect, the first caller's audio input will be masked by the synthetic voice.

In another exemplary embodiment, the voice seed generator is controlled by an enterprise system. The enterprise system may monitor calls between a first and second caller. The enterprise system voice seed generator may identify a contact associated with the first or second caller or may identify contacts associated with both callers. Based on the identified contacts, the enterprise system voice seed generator will retrieve a voice seed associated with one or each contact. Not every contact will need to be associated with a voice seed, and so the voice seed generator will not necessarily retrieve a voice seed for each contact. For contacts with associated voice seeds however, the voice seed generator can generate a synthetic voice based in part on the voice seed and an input from the first or second caller. In some instances, the voice seed generator identifies a contact as a potential risk, then, the voice seed generator will apply the voice seed associated with risky contact to the other caller so as to mask that caller's voice and protect that caller from the risky contact and associated caller.

In an embodiment, the enterprise system may monitor calls between more than two callers, as in a conference call, and can apply voice seeds to each caller or a subset of all the callers. For instance, the enterprise system can identify contacts associated with each caller within the call and retrieve an associated voice seed for each caller. In one example, the enterprise system can detect that one caller within the conference call is unidentified, anonymous, or otherwise unverified. In response, the enterprise system can retrieve voice seeds for each of the other callers in the conference call to mask each caller's voiceprint from the unverified caller.

In an embodiment, the system is local to a user's phone wherein the user is a first caller. The first caller receives a call from a second caller and the system identifies a contact associated with the second caller 201. The contact may identify the second caller as an unidentified or anonymous caller or other caller presenting risk to the first caller. The system can then retrieve a voice seed associated with the flagged contact 201. The voice seed associated with a flagged contact for instance may be a default voice seed which generates a default synthetic voice, masking the first caller's natural voiceprint. Then, the system generates a synthetic voice heard by the second caller that is based in part on the retrieved voice seed 203. The synthetic voice seed masks the first user's voiceprint as heard by the second caller.

In another embodiment, the voice seed associated with the contact may modify the second caller's voice. At step 203, when the system generates the synthetic voice, it may generate the synthetic voice by applying the voice seed to the second caller's input, so that the first caller hears a modified synthetic voice that masks or otherwise alters the second caller's voiceprint. In some cases, the voice seed may be associated with accessibility parameters to make second caller's input more accessible to the first caller.

In another embodiment, the system is not local to the first caller's phone and can identify a contact associated with the first caller, and a contact associated with the second caller. The system can then retrieve voice seeds associated with each contact 202 and generate synthetic voices based in part on each voice seed and input from both the first and second caller 203. Alternatively, only one of the first or second caller may have a contact with an associated voice seed, and thus the system may generate a synthetic voice based in part on the voice seed an input from the first or second caller 203.

The flow chart 200 of FIG. 2 does not require the system 100 to generate voice seed in every instance. In some embodiments, an associated voice seed may already have been generated before being received by the system 100. Any caller may transmit data and metadata including a voice seed to the system. In such cases, the voice seed 108 may be received and stored by the voice key database 112.

### Example Interfaces for a Voice-Key Database

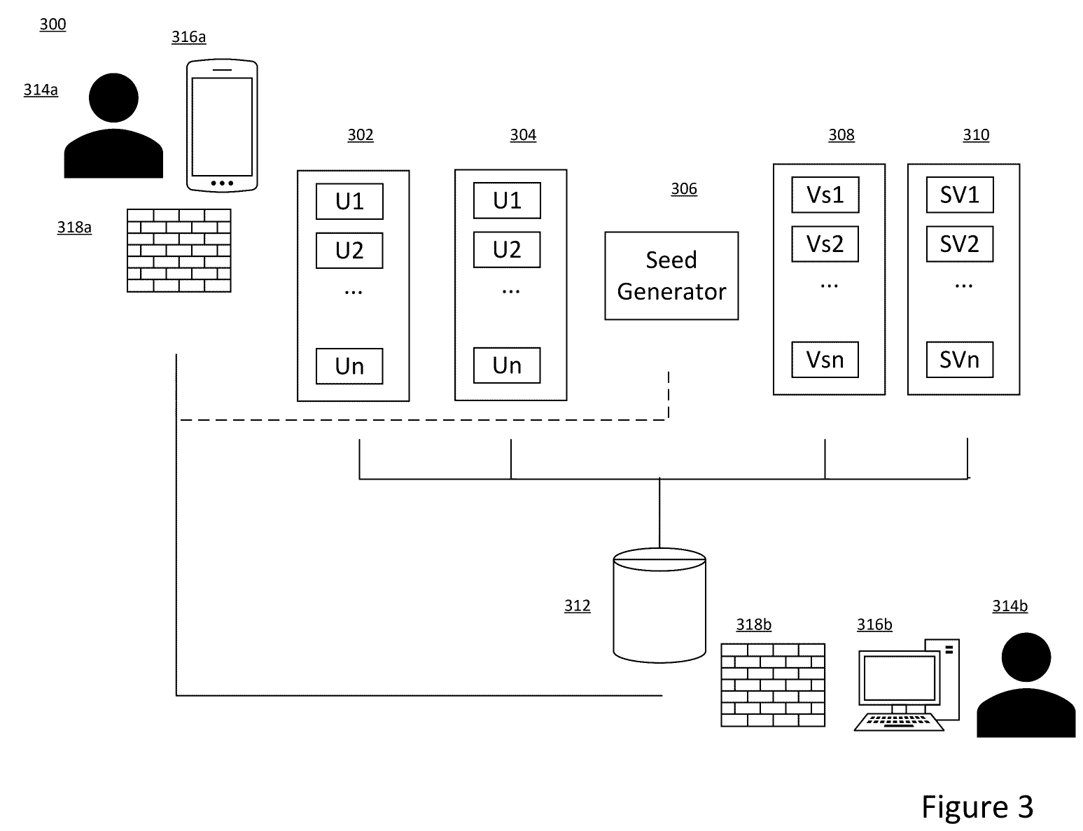

FIG. 3 shows other embodiments of the disclosure. The embodiments of system 300 demonstrate that varying levels of access may be provided to different user groups to modify voice seeds. In one embodiment for example, a user, such as the first caller 101a, may need to authenticate access 318a to be granted user access 314a. The user 314a can be provided a user interface 316a such as a mobile phone interface to modify voice seeds associated with specific contacts 302. Absent access to the user 314a, a caller may be denied the ability to modify any voice seed 308 contact associations 302. User access 314a may be controlled by a user group 314b, the user group optionally having separate access requirements 318b. The user 314b group can include network or enterprise administrators with trusted access to the voice key database network. The user group 314b may have its own interface 316b providing the user group its own abilities to modify voice seeds 308 and their associated contacts 304.

Other embodiments of the current disclosure may include a combination or subset of the listed features. For instance, in some embodiments, only the user 314a may be present and provided with a control interface 316a to modify voice seeds. In other embodiments, only the user group 314b may be present, providing access to the voice key database to network and enterprise administrators.

In an embodiment according to FIG. 3, a user 314a is shown in communication with a user interface 316a, also referred to as a voice seed generator interface. An authenticator module including security protections 316a is also shown. The user may include the first or second caller 101 discussed in FIG. 1. The user 314a is thus capable of providing input and calling another person. The user can optionally control a set of parameters input into the seed generator 306 to determine characteristics of the associated voice seed 308. The user may select a specific contact 304 and associate that contact with a specific voice seed 308. In other embodiments, the user 314a, through the user interface 316a, may modify the parameters fed into the seed generator 306 to tune a generated voice seed 308 to have desired characteristics. The user interface 316a may allow the user 314a to generate 306 a new voice seed 308 associated with a contact 304 mid-call, allowing the user 314a to modify the synthetic voice output 310 in real-time. In other embodiments still, a user within the user may refrain from selecting any modifications to be input to the seed generator and instead have a set of default voice seeds or opt for no voice seed to be associated with a contact 304.

The user security protections 318a are illustrated according to one embodiment of the present disclosure. The user can include the first or second caller described in other embodiments. In contrast, the user group refers to network administrators, system administrators, or others with access and control over callers' access to the voice key database. The security protections may comprise a firewall, two factor authentication, or any other system generally recognized in the art as distinguishing an authenticated user from a non-authenticated user. In some embodiments, only authenticated users will have access to the user interface 316a thereby allowing the authenticated user 314a, to modify the contact 304 associated voice seed 308 and corresponding synthetic voice 310. Non-authenticated users may be denied access to the voice key database 312 and be denied privileges or be given less privileges to modify voice seeds. Non-authenticated users calling into the system may be assigned a specific contact 304 reserved for non-authenticated users. A contact 304 reserved for non-authenticated callers may be associated with a specific default voice seed, or alternatively no voice seed, resulting in non-authenticated inbound callers having an authentic as opposed to synthetic voice.

The system 300 of FIG. 3 also displays a user group 314b, user interface 316b, and authenticator module including security protections 318b. In one embodiment, the user group interface 316b allows an enterprise side user 314b to control the user interface 316a as well as the contact 304 voice seed 310 associations and seed generation 306 directly. For instance, the user group 314b may limit the subset of parameters that the user 314a may modify through the user interface 316a. The user group 314b may assign a contact to a voice seed specific to authenticated users, non-authenticated users, or other specific classes of users. Alternatively, no user interface 316a may be provided, and instead the user group 314b may have unilateral control over caller's associated contacts 304 and associated voice seeds 308. The user group 314b can further modify or regenerate 306 the voice seed 308 associated with a contact 304. Security protections 318b may also be present to authenticate access to the user group 314b. The security protections again may comprise a firewall, two factor authentication, or any other system generally recognized in the art as distinguishing an authenticated enterprise side user from a non-authenticated user. Thus, access 318b to the user group controls 316b may be limited to specific subset of authenticated enterprise users 314b.

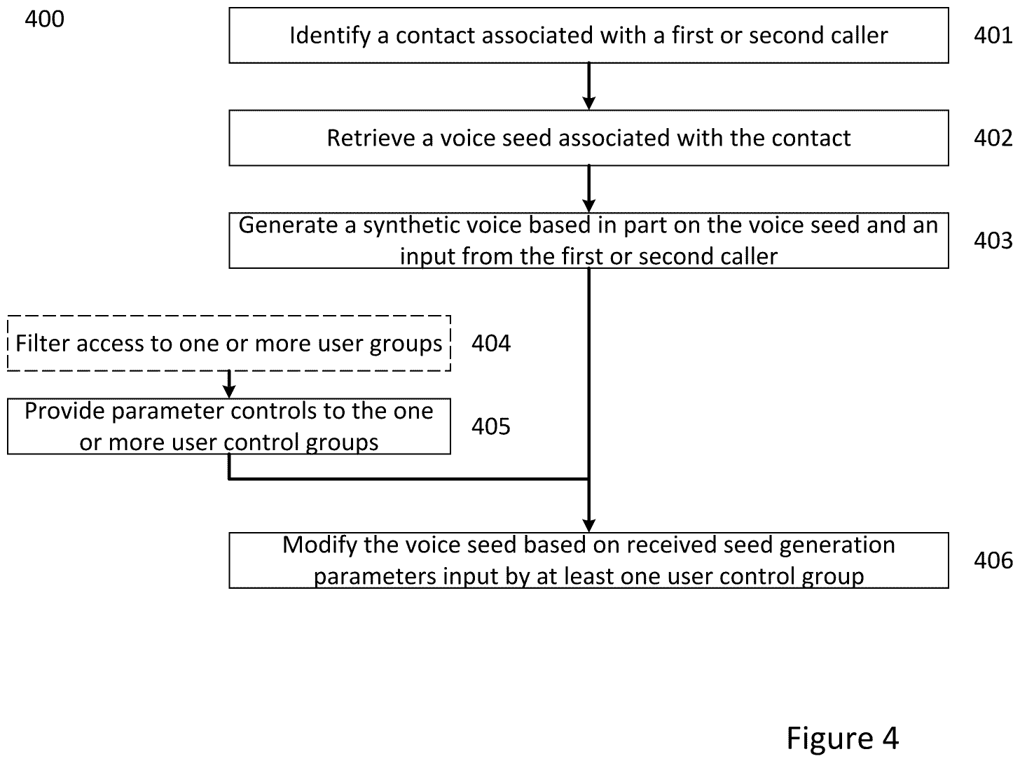

FIG. 4 depicts a flow chart according to an embodiment of the present disclosure. The steps 401-403 are similar to the steps depicted in FIG. 2. Additionally, the embodiment shown in FIG. 4 includes steps 404-406. In step 404, an authenticator module filters access to one or more user groups. For instance, authenticator modules may include a user 318a and user group 318b security authenticator. The authenticators can use multi factor authentication, password controls, VPN access, token or certificate based authentication, or any other means of limiting access between different user groups. In alternate embodiments, user security protections 318a may be present without user group security protections 318b or vice versa. Security protections 318a 318b may provide for various levels of access to various user groups. For instance, the user group including system administrators may have different levels of access within user group security controls. A top-level administrator may be filtered through the security controls and given total access. The top-level administrator control group may be able to limit the access of lower-level managers with lower-level access as filtered through the security controls. Similar filtering may occur on with respect to the user 318a. Additionally, one or more members of the user group may have the ability to modify and restrict access to the user. The user group can thus limit other users' abilities to modify the voice key database.

Filtered, restricted access to one or more user groups 404 may then be associated with specific parameter controls provided to the user group 405. A higher-level user group, such as the user group, may be provided greater ability to modify the seed generation parameters used to generate a voice seed. Modification of the seed generation parameters includes entering a modification request, allowing one of the user groups the ability to modify voice seeds and voice seed associations. The modification request may be prompted to a user group through a graphical user interface. The user group may limit the range of parameters that the user may themself use in modifying voice seeds 406. For instance, the user group may limit the users to default voice seeds. Seed generation parameters may be limited to defining a specific pitch or other vocal affect associated with a voice seed 308 and the resulting synthetic voice 310. Parameter controls provided to one or more user groups can also include modifying the voice seed associated with a contact. For instance, parameter controls can include associating specific callers with specific contacts, or specific contacts with specific voice seeds.

Filtered access and security controls provide an additional advantage in preventing multiple voice seeds and synthetic voices from being compromised. When administrative access to the voice key database is limited behind security protections, a top-level administrator may be able to prevent voice seeds, audio input voiceprints, and associated voice seeds from being further compromised. For instance, if an audio input associated with a contact is determined to an inauthentic synthetic copy, a user group member including a top-level administrator may reset or modify the associated contact's voice seed.

Flowchart 400 shows steps 404 and 405 being performed after step 403 but before step 406. It may be appreciated that steps 404 and 405 can be performed in other sequential orders. For instance, filtration 404 and providing parameter controls 405 may be performed prior to generating they synthetic voice at step 403. In some embodiment, including first use cases, steps 404 and 405 may be performed prior to step 402 wherein the voice seed generator retrieves a voice seed associated with the contact. Other orders of steps 401-406 may be practiced in other embodiments.

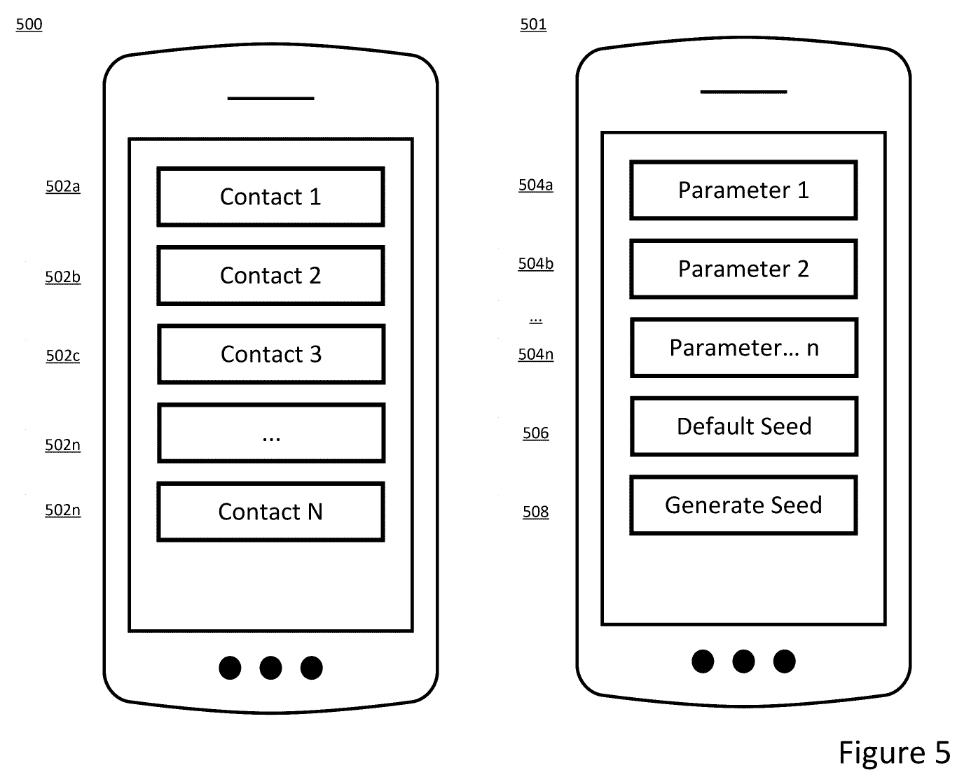

FIG. 5 shows example user interfaces 500 and 501. According to the embodiment of FIG. 5, the user interface 500 resembles a contact list. The interface displays a list of contacts 502a-502n. Once a user within a user group selects a specific contact from the list of contacts, the user is then presented with interface 501 which provides a set of parameter controls 504a-504n, as well as a default seed 506 and a generate seed button. Variations of the parameter controls and the default seed option may be provided. For instance, a variety of default seed options may be presented to the user upon selecting the default seed button 506. Parameter controls 504a-504n can include various voice modulation settings including settings to modify a voice seed's tone, pitch, and volume. Additional parameter controls can include audio accessibility parameters such as bass boosting for receiving contacts that are unable to hear higher frequencies, or mono output settings for callers with single sided deafness. Audio accessibility parameters may also allow a user to adjust a synthetic voice that is more relaxing or soothing, along with being easier to understand. With these described user interfaces, a user can generate voice seeds associated with each listed contact and store them in the voice key database. The user may, through a user interface, associate the voice seed with a contact such that the when the user, as a first caller, calls or receives a call from the second caller, the user's voice is masked by the synthetic voice. Alternatively, the user may associate, through a user interface, the voice seed with the contact such that when the second caller calls the user, the second caller's voice is modified by an associated voice seed. Once a voice seed is generated for a specific contact, future calls placed by the user to that specific contact will be applied through they voice seed, resulting in the callee hearing the output synthetic voice.

Thus, in the above described examples, a user can use the voice key application through a user interface to associate contacts with voice seeds to meet the hearing needs of the contact whom the user intends to call. The voice seed may be tagged to the contact and automatically applied in the future so that no extra user interaction on behalf the user, or the contact will be needed to implement the voice seed modification.

The user interfaces 500 and 501 may be provided to a user (316a of FIG. 3) or user group (316b of FIG. 3). The interfaces 500 and 501 of FIG. 5 are shown on a mobile device but similar user interfaces may be provided on other electronic systems including computer software. The user group 314b may be provided additional controls in the user interface 501 to limit user's 314a ability to modify contacts' associated voice seeds. Enterprise side users 314b of a network security system 318b may deny users 314a access to the user interface 500 501 altogether by denying such users access to the user.

### Example Operations of a Voice Seed Generator

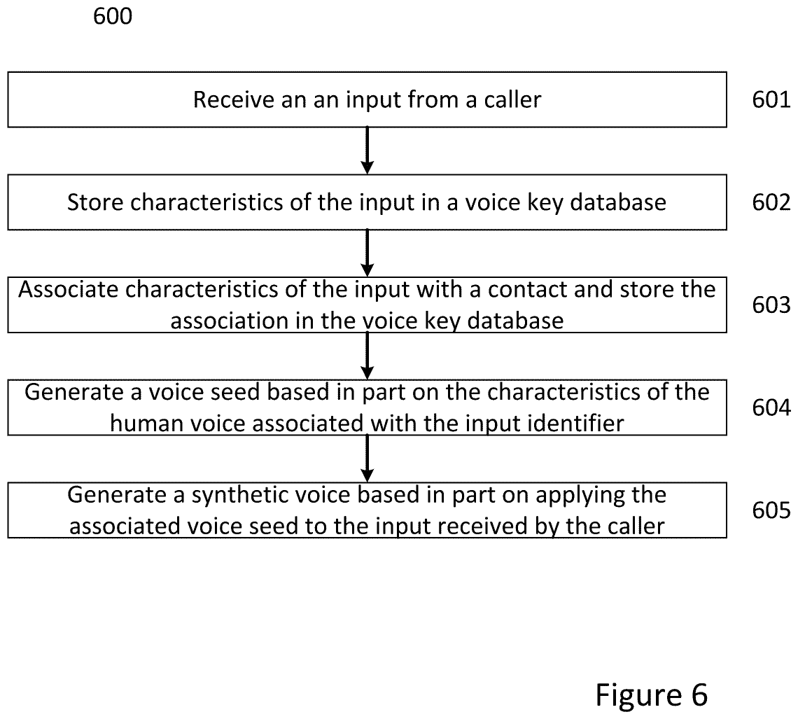

FIG. 6 illustrates flow chart 600 according to an embodiment of the present disclosure. The flow chart 600 illustrates how the voice seed generator may generate or retrieve voice seeds which produce synthetic voice outputs retaining characteristics of input audio. At step 601, the voice seed generator receives an input from a caller, The voice seed generator then stores characteristics 602 of the input in the voice key database. The characteristics of the input can include audio and voiceprint characteristics which can be processed and stored by applying audio signal processing techniques including frequency estimation, gaussian mixture modeling, pattern matching algorithms, neural networks, or decision tree logic. One of ordinary skill in the art will appreciate these and other methods for processing and storing characteristics of a speaker's voice. Voiceprint characteristics can include the audio input's pitch, frequency, pronunciation, and other identifying features.

At step 603, the characteristics of the input, e.g., the voiceprint, are associated with a contact and the association is stored within the voice key database. For instance, an enterprise receiving a call from a specific caller will record the caller's voiceprint, the caller's address, e.g., phone number, and an association between the voiceprint and the caller's address unique to that caller.

At step 604, the voice seed generator generates a voice seed based in part on the characteristics of input associated with the contact. In some embodiments, the voice seed will be generated based entirely on the associated voiceprint. In other embodiments, the voice seed will be generated in part based on the associated voiceprint and will remain partially randomized. In other embodiments still, the voice seed may be purely randomly generated, for instance, by a random number generator, and not depend on the associated voiceprint.

At step 605, the voice seed generator generates a synthetic voice based in part on applying the associated voice seed to the audio input received by the contact. In the embodiment of FIG. 6, the contact may be a human caller, and the audio input may be the human caller's digitally converted natural voice, for instance by an analog to digital converter. The voice seed generator will then apply the voice seed associated with that specific caller to the voice input to generate a synthetic voice output. The voice seed may be a function featuring characteristics of the user's previously stored voiceprint. In such cases, the output will be a synthetic voice that features aspects of the user's voiceprint and natural voice, while also containing modifications such as modulations to pitch, tone, and volume. As discussed in prior figures, the modulations may be programmed and controlled by one or more users by inputting parameters into the voice seed generator. In other embodiments still, the associated voice seed may not be generated based on a user's voiceprint and instead may be entirely randomized. In such cases, the generated synthetic voice will have no correlation to the natural voice of the caller input after being modulated by the associated voice seed.

The steps of the flow chart 600 shown in FIG. 6 may be used in combination with the embodiments of other figures. For example, the stored association between audio input characteristics and a contact recited in step 603 may be applied to the security features discussed in the example embodiment described with regard to FIG. 4. The filtration step 404 may be performed by receiving an audio input from a caller 401 and comparing that input to additional audio inputs and voiceprint characteristics associated with specific, additional contacts 603. Access to a specific user control groups would be filtered based on whether the audio input received 601 matches a stored audio input associated with a specific class of user per step 603.

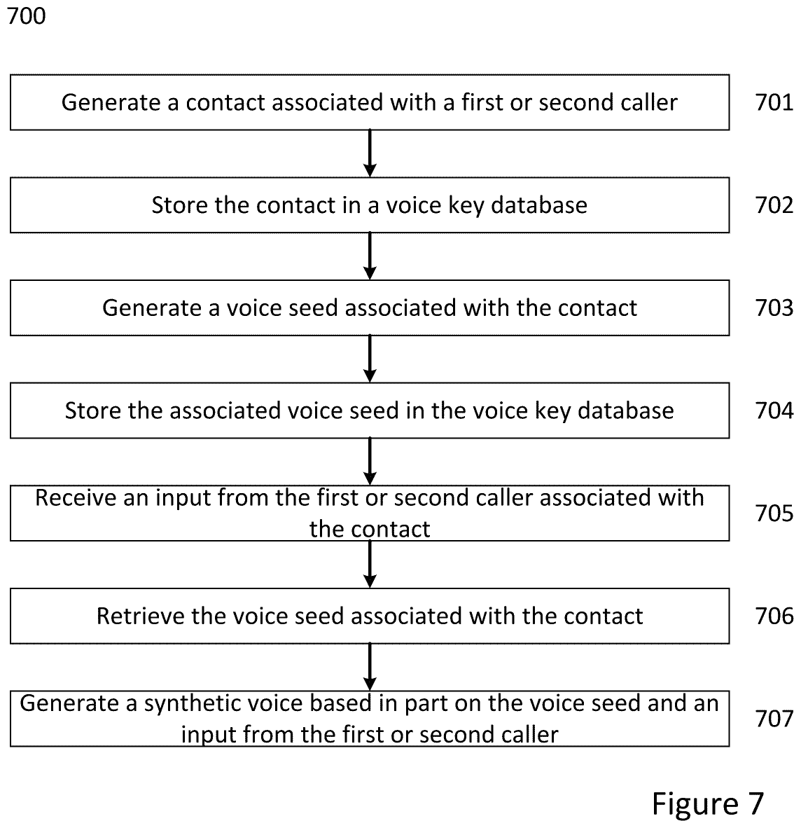

FIG. 7 illustrates a flow chart according to an embodiment of the present disclosure in which the voice seed generator generates the contacts and voice seeds in first use cases. According to this embodiment, the voice seed generator generates a contact associated with a first or second caller 701 and then stores the contact and its association with the caller 702 in a voice key database. For instance, in cases where a call is received from an unidentified or anonymous caller, the voice seed generator can generate a specific contact for storing an associated voice seed upon reception of the call from the unidentified or anonymous caller. The voice seed generated for the unidentified or anonymous caller may be a purely random seed generated on the fly. The generated voice seed may be associated with the contact for future calls.

In enterprise systems, a user group can define different sets of contacts depending on characteristics of the audio input and additional metadata, including the cell-number associated with the audio input. The voice seed generator then generates 703 the voice seed associated with the contact. The voice seed is then stored 704 in the voice key database. Once the voice seed generator receives an input from a from a first or second caller associated with the contact 705, the voice seed generator can retrieve the voice seed associated with the contact 706. The voice seed may be associated with the contact by a hash code or other unique identifier linking the voice seed to the contact. The association couples the voice seed to the contact. With the retrieved voice seed, the voice seed generator can generate a synthetic voice based in part on applying the associated voice seed to the input from the first or second caller 707. The voice seed can be associated with the contact and may contain metadata indicating to the voice seed generator to modify input from the first caller or input from the second caller to generate the synthetic voice. Additional embodiments may combine steps recited in embodiment 700 with the embodiments of other figures. In certain embodiments, a user interface like those described in FIG. 5 may be applied at step 703, wherein a user can define specific a specific voice, or characteristics of a voice seed to be generated or associated with the generated contact 701.

Other embodiments may not practice every step of the embodiment 700. For instance, a caller may be identified but not have a voice seed generated for them. In such cases, steps 701 and 702 will not be performed and the voice seed generator begin performing operations at step 703. In other embodiments, a specific voice seed may already be associated with a class of contacts and as a result the voice seed generator will not perform the step 703 of generating the voice seed for each contact. One of ordinary skill in the art will appreciate that individual steps can be skipped or rearranged according to various embodiments disclosed herein.

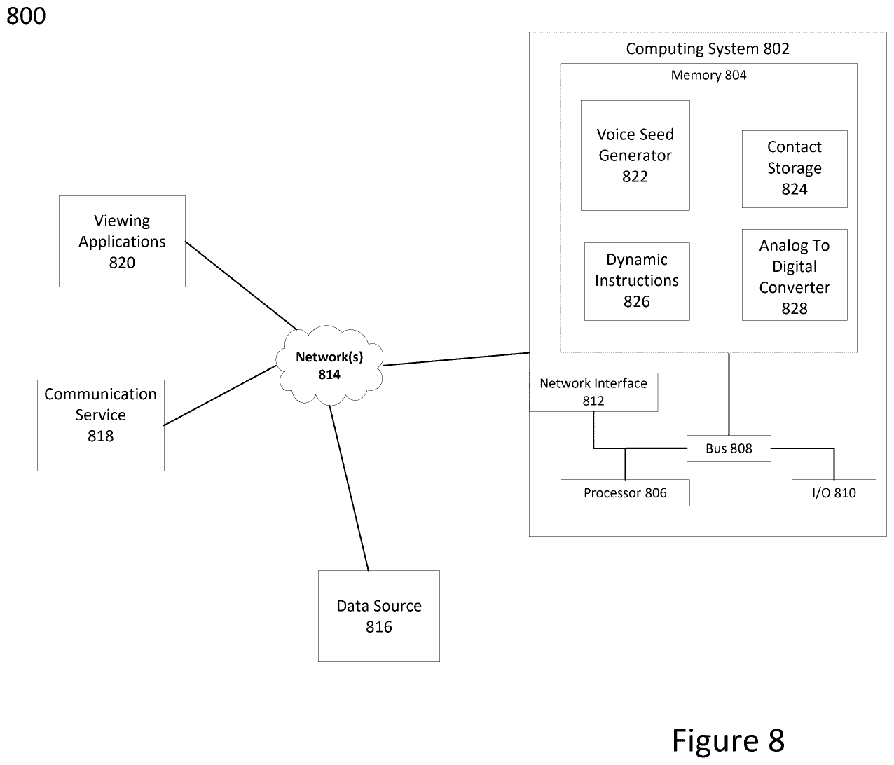

Any suitable computing system or group of computing systems can be used for performing the operations described herein. For example, FIG. 8 is a block diagram depicting a system for generating a synthetic voice based in part on identities stored in a voice key database, according to certain embodiments. Components of system 800 for instance may be used to execute functions called for by the voice seed generator 822.

The depicted example of a computing environment 800 includes a computing system 802 which includes one or more processors 806 communicatively coupled to one or more memory devices 804. The processor 806 executes computer-executable program code or accesses information stored in the memory device 804. Examples of processor 806 include a microprocessor, an application-specific integrated circuit (“ASIC”), a field-programmable gate array (“FPGA”), or other suitable processing device. The processor 806 can include any number of processing devices, including one.

The memory device 804 includes any suitable non-transitory computer-readable medium for storing program code and data from a data source 816 such as the voice key database of embodiments discussed with respect to FIG. 1 and its related parameters including the caller data, caller input data, contact data 824, the voice seed generator 822, the voice seeds, and other received or determined values or data objects. Caller input data for instance, may be stored in memory 804 after being converted by an analog to digital converter 828. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 802 may also include a number of external or internal devices such as input or output devices. For example, the computing system 802 is shown with an input/output (“I/O”) interface 810 that can receive input from input devices or provide output to output devices. Examples of input and output devices include audio processing and transmission hardware including transducers and amplifiers. A bus 808 can also be included in the computing system 802. The bus 808 can communicatively couple one or more components of the computing system 802.

The computing system 802 executes program code that configures the processor 806 to perform one or more of the operations described above with respect to FIGS. 1-7. The program code includes operations related to, for example, receiving, generating and associating inputs 102 with the contact 104, and generating, storing, and retrieving generated voice seeds 108. The program code may be resident in the memory device 804 or any suitable computer-readable medium and may be executed by the processor 806 or any other suitable processor. In some embodiments, the program code described above, the contacts 104, the associated voice seeds 108, characteristics of the audio inputs 102, and the seed generator 106 and seed generation parameters are stored in the memory device 804, as depicted in FIG. 8. Memory 804 may also include an analog to digital conversion software 828, digital to analog software, or any other software applied in audio signal processing. In additional or alternative embodiments, the contacts 104, the associated voice seeds 108, characteristics of the inputs 102, and the seed generator 106 and seed generation parameters described above are stored in one or more memory devices accessible via a data network, such as a memory device accessible via a cloud service.

The computing system 802 depicted in FIG. 8 also includes at least one network interface 812. The network interface 812 includes any device or group of devices suitable for establishing a wired or wireless data connection to one or more data networks 814 such as viewing applications 820 including user interfaces 316a and 316b. Non-limiting examples of the network interface 812 include an Ethernet network adapter, a modem, and/or the like. Remote communication services 818 are connected to the computing system 802 via network 812, and remote communication services 818 can perform some of the operations described herein, such as storing a set or subset of a data source 816. The computing system 802 is able to communicate with one or more of the remote communication services 818 and the voice key database and other data 816 using the network interface 812. Although FIG. 800 depicts the voice key database 816 as connected to computing system 802 via the networks 814, other embodiments are possible, including the voice key database 816 running as a program in the memory 804 of computing system 802.

### Advantages of Systems and Methods for a Voice-Key Database

The voice-key database offers advantages to callers and enterprises looking to protect caller voiceprints and biometric data. In some examples, the voice key database will provide protections to voice-seed users receiving calls from unverified callers. In such inbound cases, the voice seed user may associate, through a user interface, unverified callers with a specific voice seed. Then, once the voice seed user receives a call from the unverified caller, the voice seed generator will retrieve and apply the associated voice seed to the user's voice input. As a result, the unverified caller will hear only the masked synthetic voice, and the voice seed user's natural voice input or voiceprint will be protected from unverified caller threat actors who otherwise could record and replicate the voice seed user's voiceprint. An enterprise system may also perform similar operations on behalf a voice seed user, by associating all unverified callers into the system with specific voice seeds. The enterprise can protect the voice seed user's voiceprint on the voice seed user's behalf, without requiring action by the voice seed user.

In further examples, the voice seed user can beneficially use the voice-key to associate contacts with specific voice seeds to promote accessibility and to better facilitate conversations with those that are hard of hearing. If a voice seed user knows that a specific contact is hard of hearing, then the voice seed user can designate that contact user to a voice seed that boosts the voice seed user's output voice. Voice seeds can be modified to boost various frequencies that may make it easier for a hard of hearing recipient to understand the voice seed user. The voice seed user may also associate their own contact with a modified voice seed such that when the voice seed user receives calls from other callers, the other caller's input will be modified by an associated voice seed so that the voice seed user can better hear the other caller.

The voice seed database also allows for enterprise users to better facilitate automated conversations wherein a human user converses with an automated caller. The enterprise user may assign different voice seeds to the automated caller depending on the identity of the human caller, or on the identity of the task to be completed during the call. A unique and repeatable synthetic voice may be associated with each user in a call list so that conversations with an automated caller may be unique to each user in the call list.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A system comprising:
a processor configured to:
identify a contact associated with a caller;
retrieve a voice seed associated with the contact; and
generate a synthetic voice based in part on the voice seed and an input from the caller.

2. The system of claim 1, wherein the processor is configured to identify the contact associated with the caller by:
providing a user a contact list;
receiving a selected contact;
providing the user a voice seed generator interface;
receiving a request to generate an associated voice seed;
generating a voice seed associated with the selected contact; and
storing the voice seed in a voice key database.

3. The system of claim 2, wherein the user comprises the caller, and the input is audio provided by the caller.

4. The system of claim 2, wherein the processor is further configured to modify the voice seed associated with the contact based on a modification request received from the user.

5. The system of claim 4, wherein modifying the voice seed associated with the contact further comprises:
receiving one or more seed generation parameters from the user; and
generating the voice seed from input of the seed generation parameters.

6. The system of claim 5, wherein the one or more seed generation parameters include audio accessibility parameters.

7. The system of claim 4, wherein the processor is further configured to restrict access to the voice seed generator interface by authenticating the user.

8. The system of claim 4, wherein the user is associated with a user group and the processor is further configured to restrict access to the voice seed to members of the user group.

9. The system of claim 1, wherein the caller is an automated caller. and the input is text to speech machine generated input provided by a user or user group.

10. The system of claim 4, wherein generating the synthetic voice based in part on the voice seed and an input from the caller comprises retaining one or more voiceprint characteristics of the input from the caller.

11. A method including operations executed by one or more processors, the operations comprising:
receiving an input from a caller;
identifying a contact associated with caller;
retrieving a voice seed associated with the contact; and
generating a synthetic voice based in part on applying the associated voice seed and an input from the caller.

12. The method of claim 11, wherein the processor is configured to identify the contact associated with the caller by:
providing a user a contact list;
receiving a selected contact;
providing the user a voice seed generator interface;
receiving a request to generate an associated voice seed;
generating a voice seed associated with the selected contact; and
storing the voice seed in a voice key database.

13. The method of claim 12, wherein the user comprises the caller, and the input is audio provided by the caller.

14. The method of claim 12, wherein the processor is further configured to modify the voice seed associated with the contact based on a modification request received from the user.

15. The method of claim 14, wherein modifying the voice seed associated with the contact further comprises:
receiving a plurality of seed generation parameters from the user; and
generating the voice seed from input of the seed generation parameters.

16. The method of claim 15, wherein the plurality of seed generation parameters includes audio accessibility parameters.

17. The method of claim 14, wherein the processor is further configured to restrict access to the voice seed generator interface by authenticating the user.

18. The method of claim 11, wherein the user is associated with a user group and the processor is further configured to restrict access to the voice seed to members of the user group.

19. The method of claim 11, wherein the caller is an automated caller, and the input is text to speech machine generated input provided by a user or user group.

20. A non-transitory computer-readable medium embodying program code that, when executed by one or more processors, causes the processors to perform operations comprising:
receiving an input from a caller;
identifying a contact associated with the caller;
retrieving a voice seed associated with the contact; and
generating a synthetic voice based in part on applying the associated voice seed and an input from the caller.
